(19) United States
(12) Patent Application Publication
(10) Pub. No.: US 2003/0154483 A1
(43) Pub. Date: Aug. 14, 2003

(54) Interface device intended to be used with a multi-media content restitution device to perform searches on a multi-media content being restored

(76) Inventors: Benoit Mory, Paris (FR); Franck Laffargue, Poissy (FR); Nicolas Santini, Paris (FR)

Correspondence Address: Michael E. Marion, c/o U.S. PHILIPS CORPORATION, Intellectual Property Department, 580 White Plains Road, Tarrytown, NY, 10591, US

(21) Appl. No.: 10/349,239

(22) Filed: Jan. 22, 2003

(30) Foreign Application Priority Data
Jan. 22, 2002 (FR) 0200769

(51) Int. Cl. G06F 3/00; H04N 5/445; G06F 13/00; G06F 15/16

(52) U.S. Cl. 725/53; 709/219

(57) ABSTRACT

The invention proposes an interface device with a screen intended to be used with a device for restitution of multi-media content (for example a television) to perform searches on a multi-media content being restored.

The interface device according to the invention allows the user to navigate in a history of multi-media content entities which have already been restored to select an entity on which he wishes to perform a further search. A question is then formulated automatically and sent to a search engine. The proposed search results are transmitted to the interface device where they are displayed. The user can select a search result for display.

### FIELD OF THE INVENTION

The invention relates to electronic apparatus comprising a multi-media entity restitution device, means for formulating a question to be used for a search from a search request emanating from a user, and means of connection to a transport network to transmit said question, receive proposed search results, transmit a search result request emanating from the user and receive the requested search result.

The invention also relates to an interface device intended to operate with a multi-media entity restitution device.

It also concerns a system comprising at least one transport network, electronic apparatus of the type described above, a search engine and a server. The invention applies in particular to television.

### BACKGROUND OF THE INVENTION

European patent application EP 1094406A2 describes a data recovery system in which requests formulated orally by a user are analyzed to generate a question sent to a search engine via the Internet. The system allows, for example, a television viewer to obtain directly from his television further information on a program he is watching. The search results are displayed on the television screen or supplied in the form of a synthesized voice message.

### SUMMARY OF THE INVENTION

An object of the invention, in particular, is to propose another solution allowing the user of a multi-media entity restitution device, for example a television viewer, to obtain further information on the multi-media entities restored.

For this, an apparatus according to the invention and as described in the introductory paragraph is characterized in that it comprises an interface device with a display screen, a user interaction element and means of communication with said restitution device to:

receive and display first data representative of the multi-media entity being restored,

allow the user to navigate through a history of first data received to ask for a search relating to a multi-media entity,

receive and display second data representative of one or more proposed search results,

allow the user to navigate through said second data to request a search result,

receive and display said search result.

The invention, therefore, offers the user an interface device separate from the restitution device which enables him to select a multi-media entity already restored in order to request a search relating to this multi-media entity. The proposed search results and the search results selected by the user are displayed on the interface device and not on the restitution device, which prevents disrupting other potential users of the restitution device.

To make the interface user-friendly, said first and second data comprise text and/or images. Said text and/or images are extracted from one or more files describing said multi-media entities.

For example, the text is taken from a first file written in a navigation language which contains descriptions relating to several multi-media entities (for example an MPEG-7 file). The images are key images associated with a multi-media entity and taken from a second file which is an image file to which the descriptions of the first file refer.

For best use of the available screen surface at any time, said images are advantageously displayed in a first part of the screen, at least one text associated with said images is advantageously displayed in a second part of the screen, and a multi-media entity or search result described by said text is advantageously displayed instead of said text in the second part of the screen. Furthermore, said second data are advantageously displayed instead of said first data.

In a first embodiment, the interface device according to the invention comprises means for formulating a question intended to be used to process said search request, and means of connection to a transport network to transmit said question, receive said proposed search results, transmit said request for search results and receive the requested search result.

In a second embodiment, the means of formulating a question intended to be used to process said search result, and the means for connection to a transport network to transmit said question, receive said proposed search results, transmit said search result request and receive the requested search result, are contained in the restitution device. The second embodiment limits the calculation load of the interface device.

Only the second embodiment is described in detail in the description which follows.

### BRIEF DESCRIPTION OF THE DRAWINGS

These and other aspects of the invention are apparent from and will be elucidated with reference to the embodiments described hereinafter.

In the drawings:

FIG. 1 shows a diagram of an example of the system according to the invention,

FIGS. 2 to 4 show different screen displays of an interface device according to the invention.

### DESCRIPTION OF THE INVENTION

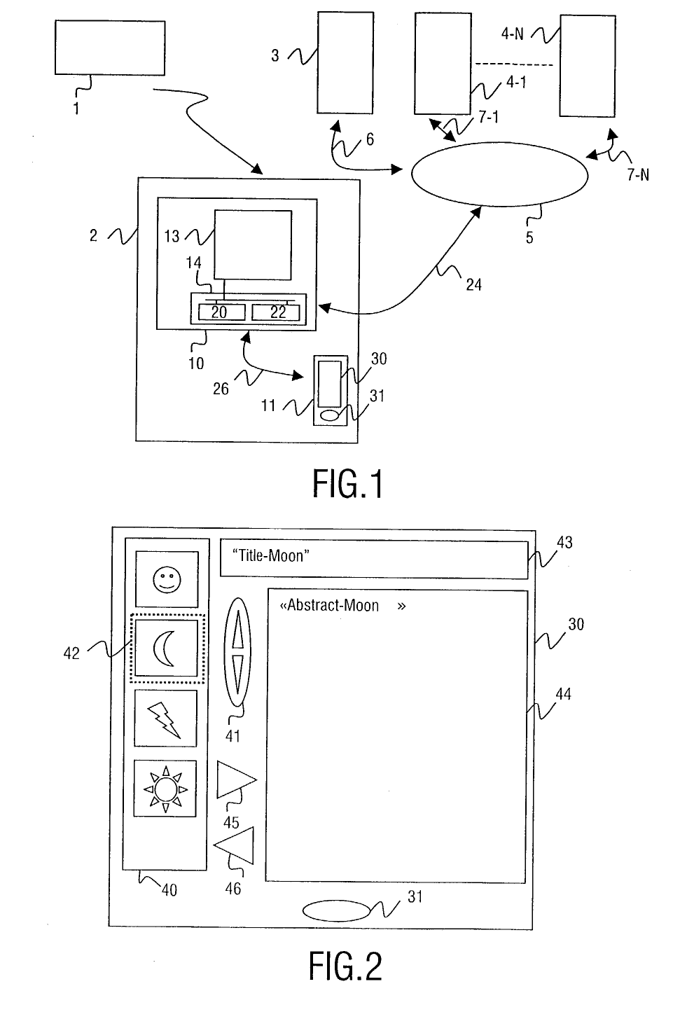

FIG. 1 shows an example system according to the invention. The system in FIG. 1 comprises a broadcaster 1 intended to broadcast the multi-media content containing one or more multi-media entities, an apparatus 2 intended to receive a multi-media content broadcast by broadcaster 1, a search engine 3, servers 4-1 to 4-N, and a transport network 5. The transport network 5 consists, for example, of the Internet.

Search engine 3 and servers 4-1 to 4-N have means of connection to transport network 5, referenced 6 and 7-1 to 7-N respectively.

The multi-media content is, for example, a television program, typically a news program containing a plurality of subjects, each subject corresponding to a multi-media entity.

The apparatus 2 comprises a device 10 for restitution of the multi-media content and an interface device 11. In the example described here, the device 10 for restitution of the content comprises a television 13 and a decoder 14. The decoder 14 also has conventional means 20 for decoding broadcast multi-media content, means 22 for formulating a question intended to be used to process a search request, and means 24 for connection to the transport network 5 to transmit a question, receive proposed search results, transmit a search result request and receive the requested search result.

The decoder 14 and the interface device 11 have communication means 26 to exchange data. Advantageously, these communication means 26 are wireless communication means.

The interface device 11 also has a display screen 30 and an element 31 for interaction with the user (for example a mouse, or pen if screen 30 is a touch screen).

According to the invention, the interface device 11 is intended to:

receive first data representative of the multi-media entity being restored and originating from the restitution device 10,

display said first data,

allow a user to navigate through a history of first data received to request a search relating to a multi-media entity,

receive second data representative of one or more proposed search results originating from the restitution device 10,

display said second data,

allow the user to navigate through said second data to request a search result,

receive said search result originating from the restitution device,

display said search result.

In the example described here, the broadcaster 1 broadcasts, as well as the multi-media content, one or more files associated with and describing said multi-media content. These files contain metadata relating to a particular multi-media content. For example, for a given multi-media content, the broadcaster 1 transmits a MPEG-7 type file containing descriptions relating to one or more entities of the multi-media content, and an image file containing an image (or key frame) for each multi-media entity. The MPEG-7 file contains, in particular, for each multi-media entity, a description instance of the MPEG-7 descriptor “MediaLocator” which contains a pointer to the part of the image file containing the image representing the multi-media entity. The MPEG-7 file also contains for each multimedia entity a description instance of the MPEG-7 descriptor “Title” and a description instance of the MPEG-7 descriptor “Abstract”.

For example, the first data relating to a multi-media entity received and displayed by the interface device 11 consists of:

the image representing said multi-media entity,

the text contained in the description instance of the MPEG-7 descriptor “Title” relating to said multi-media entity,

and the text contained in the description instance of the MPEG-7 descriptor “Abstract” relating to said multi-media entity.

Advantageously, when the restitution device 10 restores a multi-media entity of the multi-media content, it extracts from the MPEG-7 file and the image file associated with said multi-media content the first data relating to the multi-media entity being restored. It then transmits these to the interface device 11.

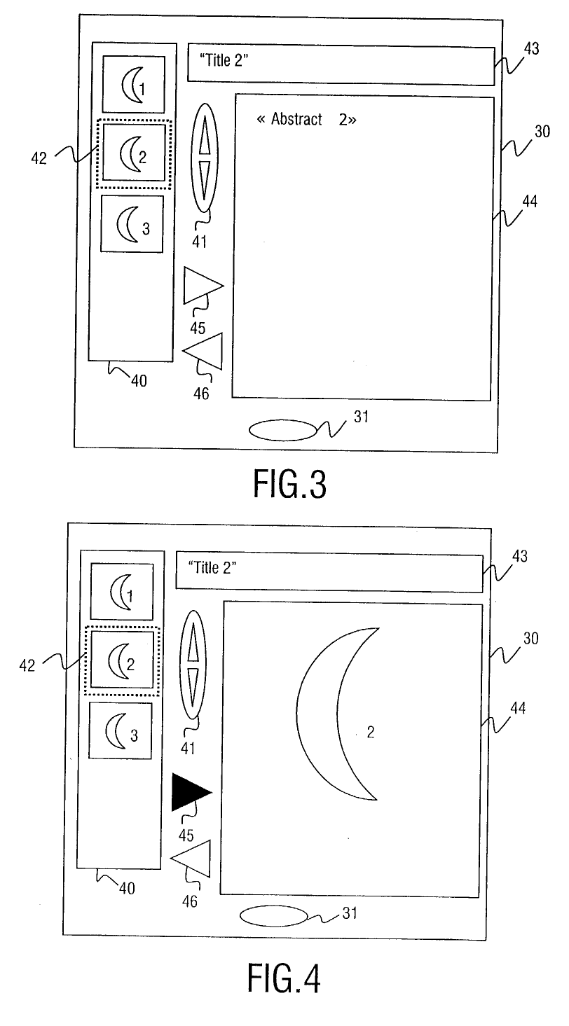

The interface device 11 displays a history of the first data received. For example, this history consists of representative images of the multi-media entities for which the first data have been received. In FIG. 2, the images are shown in line. This linear presentation of images occupies a first part 40 of screen 30. The interaction element 31 allows selection of a multi-media entity by moving along line 40 using a scroll button marked 41. In FIGS. 2 and 3, the image representative of the entity currently selected is surrounded by a dotted frame marked 42. When the user activates the scroll button 41, frame 42 moves along line 40. Text data contained in the first data relating to the multi-media entity selected is displayed in other parts of the screen. In FIG. 2, the title of the multi-media entity selected is displayed in a second part 43 of screen 30, and the abstract of the multi-media entity selected is displayed in a third part 44 of the screen 30. When the frame 42 is moved from one image to another in the image line, the text displayed in the second and third parts of the screen is modified accordingly.

The interaction element 31 thus allows activation of a button 45 displayed on screen 30 of the interface device 11 to request a search relating to the multi-media entity currently selected.

When the user requests a search, a question is formulated by the restitution device 10. Advantageously, the question is formulated automatically, for example ,using a question formulation process as described in French patent application no. 0111184 not yet published, filed on Aug. 28, 2001 by the company Koninklijke Philips Electronics N.V. This patent application describes an automatic formulation process for a question intended to be transmitted to a search engine on restitution of a multi-media content described in a document containing descriptions (for example an MPEG-7 file). This process comprises the following stages:

a stage of selection by the user from the multi-media content being restored,

a stage of extraction to extract information of context relative to said selection from the multi-media content (for example the current read time),

a stage of restitution of one or more descriptions in the document describing the multi-media content from the context information,

a stage of automatic formulation of the question from information recovered in the document describing the multi-media content.

The question formulated is then sent to the search engine 3. Search engine 3 returns the second data representative of proposed search results (the number of proposed search results is arbitrary). These second data contain, for example, image and/or text. They are, for example, taken from MPEG-7 files and/or image files of the type described above.

The second data are sent by the restitution device 10 to the interface device 11. They are displayed by the interface device 11. Advantageously, the second data are displayed instead of the first data as shown in FIG. 3. This means that:

images representative of the search results are displayed in line in the first part 40 of screen 30,

the title of the result is displayed in the second part 43 of screen 30,

the abstract of the result is displayed in the third part 44 of screen 30.

The interaction element 31 allows activation of the scroll button 41 to select a search result. The user can then request the search result currently selected by activating button 45. The interface device 11 then transmits a search result request to the restitution device 10. The restitution device 10 in turn transmits the request to one of the servers 4-1 to 4-N via the transport network 5. The server returns the result to the restitution device 10 which transmits it to interface device 11. The search result is then displayed instead of the text of the abstract in the third part 44 of screen 30 as shown in FIG. 4.

At any moment, the user can select another search result in the line of images 40. The text displayed in the second and third screen parts 43 and 44 is updated in accordance with the selection made by the user. When the interface device receives the new search result, this is displayed instead of the abstract in the third part of the screen 44.

Advantageously, a return button 46 is provided to allow the user to return to the history of the first data.

Throughout these operations, the multi-media content in process of restitution at the restitution device 10 continues to be restored normally without disruption due to the various search requests.

In a variant of the invention not shown, files associated with the multi-media content being restored are supplied by a producer of metadata which has means of connection to the transport network 5.

1. An interface device (11) comprising at least one display screen (30), an element (31) for interaction with a user, means (26) for communication with a restitution device (10) for restitution of multi-media entities to:
receive and display first data representative of the multi-media entity being restored,
allow a user to navigate in a history of first data received to request a search relating to a multi-media entity,
receive and display second data representative of one or more proposed search results,
allow the user to navigate through said second data to request a search result,
receive and display said search result.

2. An interface device as claimed in claim 1, characterized in that said first and second data comprise text and/or images.

3. An interface device as claimed in claim 2, characterized in that said text and/or said images are taken from one or more files describing said multi-media entities.

4. An interface device as claimed in claim 2, characterized in that said images are to be displayed in a first screen part (40), at least one text associated with one of said images is to be displayed in a second screen part (44), and a multi-media entity or a search result described by said text is to be displayed instead of said text in the second screen part (44).

5. An interface device as claimed in claim 1, characterized in that said second data are displayed instead of said first data.

6. An interface device as claimed in claim 1, characterized in that it comprises means of formulating a question intended to be used to process said search result, and means of connection to a transport network to transmit said question, receive said proposed search results, transmit said search result request and receive the requested search result.

7. Electronic apparatus (2) comprising:
a device (10) for restitution of multi-media entities,
means (22) for formulating a question intended to be used to perform a search from a search request emanating from a user,
means (24) for connection to a transport network to transmit said question, receive said proposed search results, transmit a search result request emanating from the user and receive the requested search result, characterized in that it comprises an interface device with a display screen, an element for interaction with the user and means of communication with said restitution device in order to:
receive and display first data representative of the multi-media entity being restored,
allow a user to navigate in a history of first data received to request a search relating to a multi-media entity,
receive and display second data representative of one or more proposed search results,
allow the user to navigate through said second data to request a search result,
receive and display said search result.

8. Electronic apparatus as claimed in claim 7, characterized in that said restitution device comprises means of receiving the multi-media content comprising one or more multi-media entities, and files associated with said content, said files containing said first data.

9. System comprising at least one transport network (5), electronic apparatus (2) as claimed in claim 7, a search engine (3) intended to receive a question, perform a search from said question and return one or more proposed search results, and a server (4-1 to 4-N) intended to receive a search result request and supply a search result.

10. System as claimed in claim 9 comprising at least one content broadcaster (1) for broadcasting contents comprising one or more multi-media entities and files associated with said contents, said files containing said first data.
